(19) United States
(12) Patent Application Publication
(10) Pub. No.: US 2013/0309643 A1
(43) Pub. Date: Nov. 21, 2013

(54) Simulated Blood Pumping System For Realistic Emergency Medical Training

(71) Applicant: Stuart Charles Segall, La Jolla, CA (US)

(72) Inventor: Stuart Charles Segall, La Jolla, CA (US)

(21) Appl. No.: 13/473,597

(22) Filed: May 17, 2012

(51) Int. Cl. G09B 23/30

(52) U.S. Cl. CPC G09B 23/303
USPC 434/268

(57) ABSTRACT

A casualty simulation and training tool for emergency medical response training, includes a simulated-blood pumping system contained within a backpack that supplies simulated blood to wound appliances worn by the injured person that provide realistic simulations of actual wounds. The wound appliances “bleed” upon activation of the system by the injured person or a remote operator, and provide a realistic simulation of injuries for emergency medical response training.

### FIELD OF THE INVENTION

The present invention relates generally to casualty simulation and medical response team training systems. The present invention is more particularly, though not exclusively, a backpack-mounted simulated-blood pumping system and associated wound apparatus allowing the wearer to simulate injuries for purposes of casualty simulation and medical response training.

### BACKGROUND OF THE INVENTION

The United States military spends hundreds of millions of dollars annually training thousands of Sailors, Marines, Injured persons, and Airmen for combat operations, while other civilian specialized first responder programs do the same for paramedics and other first responder teams. Because real world accidents or life and death or combat situations are not always an effective or desirable manner to conduct for training events, simulation of events has long been an indispensible training tool.

Acquisition of expertise in any discipline requires practice. Simulation of combat situations minimizes costs; at the same time simulation provides military personnel and civilian first responders with realistic training scenarios. From electronic tank or flight simulators to cardiopulmonary resuscitation (CPR) dummies, the United States government conserves many resources by using computers and other training aids to simulate actual operational conditions allowing procedures training in a controlled environment. Simulators of all kinds minimize risk of loss of assets and save on fuel costs, ammunition, and even the lives of the very people being trained.

Combat medical or first responder teams are groups that benefit greatly from simulation. It is not practical, nor realistic, to expect Corpsmen, Medics, or Paramedics to hone their skills exclusively on real people in real life-threatening situations. Thus, individuals with such responsibilities derive significant training value from implementation of tactics, techniques, and procedures in a realistic, but simulated operating environment, prior to being faced with a real world scenario.

Many systems have been developed to fulfill necessary training requirements by simulation. A wide range of technologies are currently employed, from complex simulation environments that fully recreate an operating room experience, to computer programs and table-top equipment that allow technicians to rehearse medical decision-making and the performance of specific tasks.

Many of these systems are cost prohibitive due to the level of technology involved in the device. Further, many systems are too big or bulky and simply not conducive to mobility or training in the field. Due to the current state of the economy and the fiscally constrained environment within which government agencies continue to work, compact, less expensive, and more versatile and realistic training aids are necessary to complete efficient and effective training of medical response personnel.

In light of the above, it would be advantageous to provide a compact, versatile, and portable injury simulation system that provides a realistic experience to emergency medical teams in a controlled training environment.

### SUMMARY OF THE INVENTION

The Simulated Blood Pumping System of the present invention provides a portable and versatile answer to on-the-ground training needs for military Corpsmen and Medics, and civilian first responder teams. A reservoir holding a finite volume of simulated blood is contained within a backpack. A pumping system pumps the simulated blood through tubing to simulated wound appliances worn on the individual's torso or extremities. Wound appliances provide a realistic appearance of actual injuries, while the pumping system supplies simulated blood to the wound appliance, adding to the realism. Each wound appliance contains a shield, protecting the individual's limb from damage from tourniquets or bandage application. The simulated blood and wounds are further designed to smell, feel, and act like an actual injury.

The present invention further provides a remote activation system by which the blood pumping system may be controlled and actuated, eliminating the need for wires and allowing for flexibility in operation. The remote activation system allows the operator or wearer to activate the pump and valves contained within the pumping system to create a realistic battlefield-training environment.

### DESCRIPTION OF THE DRAWING

The objects, features, and advantages of the method according to the invention will be more clearly perceived from the following detailed description, when read in conjunction with the accompanying drawing, in which:

FIG. 1 depicts the present invention as worn by an injured person in a simulated medical emergency situation and includes a backpack-mounted simulated blood pumping system with multiple wound appliances in wireless communication with a dedicated remote control unit, and with a master control at a command center capable of controlling multiple backpack-mounted systems;

FIG. 2 is a line drawing of a backpack-mounted simulated-blood pumping system of the present invention, including a reservoir containing a volume of simulated blood, a pump in fluid communication with the reservoir and controlled by a controller having a power supply, the pump supplying pressurized, simulated blood to a manifold that leads to multiple wound appliances, and a valve for selecting blood flow to the various connected wound appliances;

FIG. 3 depicts a wound appliance positionable on the injured person's leg, arm, head or torso during training and includes a tourniquet shield to protect the injured person from pressure applied to stop the simulated bleeding from the simulated wound appliance and a wound supply hose to receive the simulated blood from the pumping system;

FIG. 4 depicts a remote control system that allows control of the blood pumping system from a distance, such as during a realistic training exercise;

FIG. 5 depicts a master control, implemented to provide control to a remote operator over multiple backpack-mounted simulated blood pumping systems simultaneously to create real-world battlefield scenarios with multiple injured; and

FIG. 6, depicts an embodiment of a wound appliance and tourniquet as applied to the injured person's forearm, showing the simulated wound, tourniquet, tourniquet shield, and wound hose that receives the simulated blood from the pumping system.

### DETAILED DESCRIPTION

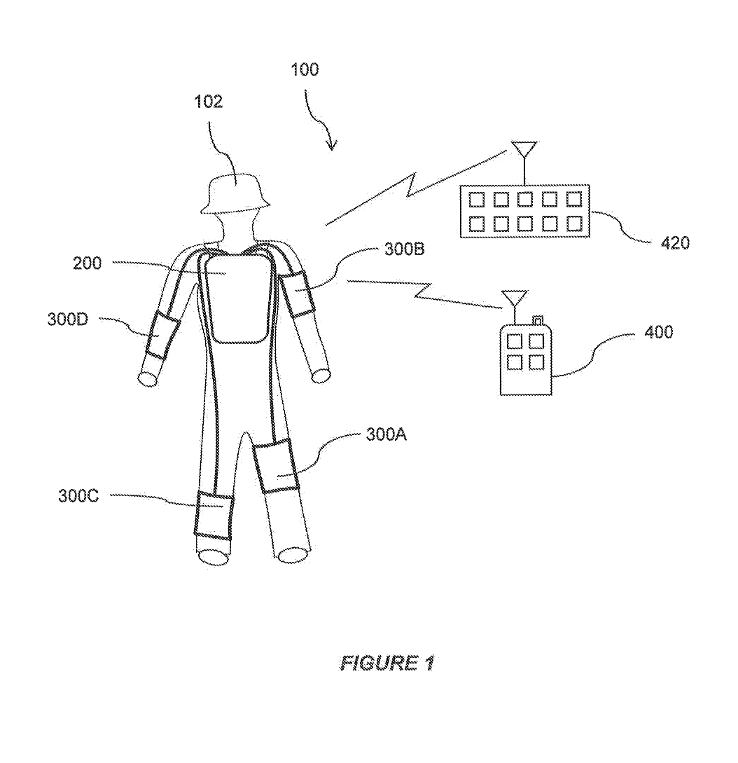

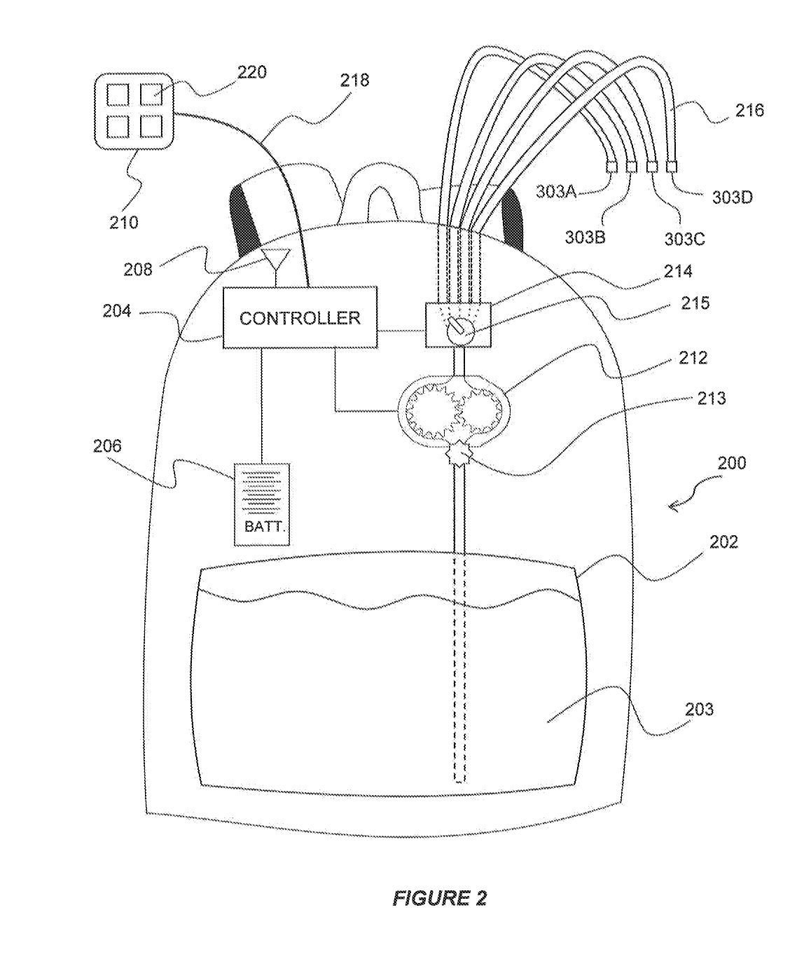

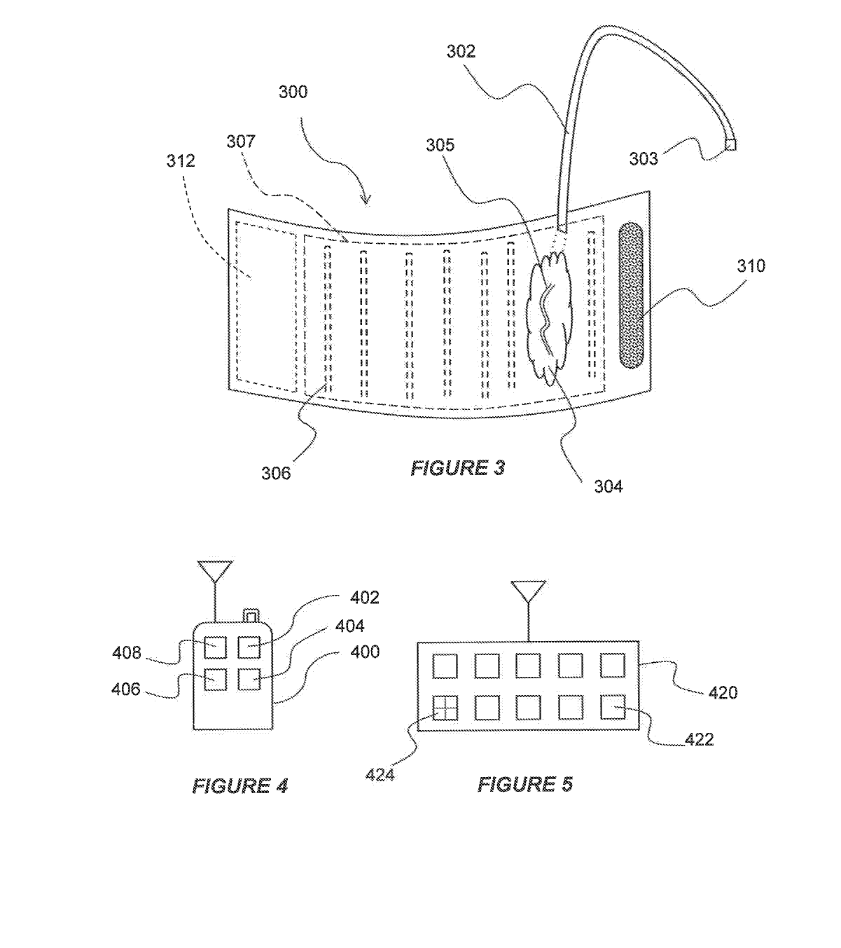

The present invention incorporates a method and apparatus for simulating real world casualties in a training environment. Initially referring to FIG. 1, an emergency medical training system, generally labeled 100, includes a backpack-mounted simulated blood pumping system 200, multiple wound appliances 300A-F, a remote control 400, and a master control 420. The individual wearing the emergency medical training system (“injured person”) 102 wears the backpack-mounted blood pumping system 200 as he or she would an ordinary backpack. The wound appliances 300 are securely fit to the injured person's 102 extremities, head, or torso as required by a training scenario. The backpack-mounted simulated blood pumping system 200 of the present invention supplies simulated blood to up to four different, selectable wound appliances 300 through supply hoses 216, shown in FIG. 2, and wound hoses 316, as shown in FIG. 3, upon activation by a signal transmitted from the operator through a wired control 210, remote control 400, or master control 404.

Referring to FIG. 2, an embodiment of the present invention includes the backpack-mounted simulated blood pumping system, generally labeled 200, that contains a collapsible reservoir 202 holding a volume of simulated blood 203. An embodiment of the invention may contain a volume of simulated blood 203 that is approximately the actual volume of blood in the human body which, if lost, will result in death. A computer controller 204, powered by power supply 206, is configured to receive discrete control signals from wired control 210 through control wire 218, or through antenna 208 from remote control 400 or master control 420. The control signals are coded such that the operator may transmit control signals to the backpack-mounted simulated blood pumping system 200, to activate the pump 212, and select which hose or hoses 216, and associated wound appliances 300 are supplied simulated blood via the computer-controlled valve or valves 214.

In a preferred embodiment, supply hoses 216 supply the simulated blood 203 to wound appliances generally labeled 300, in FIG. 3, through wound hose 302 to wound simulation 304, so that the simulated blood will exit large realistic-looking cuts 305 or other apparent wounds. Wound hose 302 may be connected to any supply hose 216 using self-sealing connector 303, allowing flexibility in selection of wound appliances 300 used for a particular training scenario. The self-sealing connectors 303 are the same for each wound appliance 300 and supply hose 216, and are designed such that the connectors 303 do not leak if not connected to a wound appliance 300 during a particular exercise.

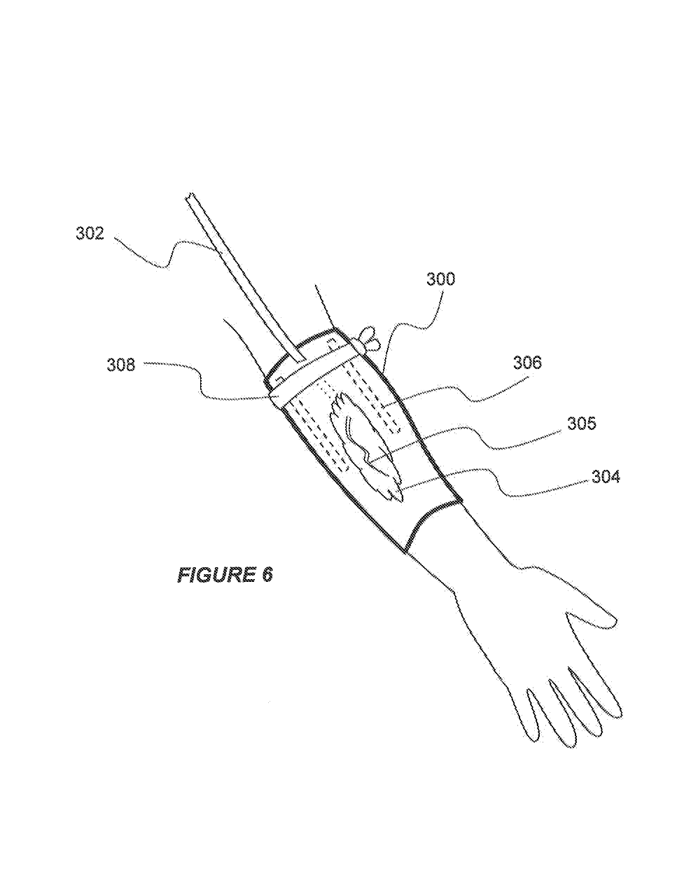

Since casualty simulations often require procedures including the use of tourniquets, an embodiment further includes wound appliances 300 that have tourniquet shields 306 (“shields”) to protect the injured person 102 from actual injury from the application of tourniquet(s) 308 or similar measures during a simulation exercise, as depicted in FIG. 6. The shields 306 are situated such that the injured person 102 retains flexibility of the area upon which the wound appliance 300 is fitted, but also allows tourniquet 308 (shown in FIG. 6) to be applied to the simulated injury to stern the flow of simulated blood. Shields 306 prevents any discomfort or pain from the application of the tourniquet 308.

In a preferred embodiment, shields 306 may be a series of stays that reside within the wound appliance 300 and longitudinally aligned with the injured person's limb. Alternatively, wound appliance 300 may include a curved sheet 308 of semi-rigid material that wraps around the injured person's limb and protects the limb from injury resulting from pressure needed to stem blood flow.

Current shields are made of a 1 inch shield of ABS plastic, and formed to the curvature of the body on which the shield is placed.

The wound appliance is comprised of platinum silicone, impregnated with a nylon mesh, with a silicone pigment added to simulate skin tone, and caulked with silicone. Silicone tubing connect to the appliance with plastic fittings. Medical makeup consisting of skin illustrator, charcoal powder, coffee grounds, and simulated blood is then applied.

The wound appliances 300 are secured to the injured person 102 by a fastening system 310 and 312. The fastening system 310 and 312 of a preferred embodiment include a hook-and-loop fastener, such as Velcro. In use, wound appliance 300 is wrapped around a injured person's limb and fastener 312 is positioned to engage fastener 310 to secure the wound appliance in place. Alternative fasteners, such as snaps, zippers, elastic, or other similar systems known in the art that allow a secure and comfortable fit to the injured person 102 while still providing flexibility are fully contemplated herein.

Referring back to FIG. 2, in use, the injured person 102 may activate the system autonomously through a wired control 210. The wired control 210 is formed with sufficient controls 220 allowing the activation or deactivation of the pump 212, so as to regulate the supply of simulated blood to the individual wound appliances 300 in use. The wired control system 210 is electrically connected through wires 218 to the computer controller 204 and allows the injured person 102 to autonomously select which wound appliances 300 are activated, through depression or activation of the controls 220. The wired control 210 may be disconnected from the system 200 if its use is not desired.

Referring now to FIG. 4, an alternative embodiment of the simulated blood pumping system of the present invention includes a remote control 400 that allows the injured person 102 or a remote operator to activate or deactivate the pump 212 and select which wound appliances 300 are utilized. Remote control 400 is formed with multiple controls 402, 404, 406 and 408 to allow the operator to activate, deactivate, or regulate the pump 212 and the supply of simulated blood 203 to the various wound appliances 300. Depression or activation of controls 402 results in the transmission of a discrete radio frequency (RF) signal from the remote control 400 antenna 208 and to the computer controller 204. Each simulated blood pumping system 200 of the present invention is identifiable with its own specific and unique serial number or digital identification number. By creating a radio signal that is coded with the unique serial number, the corresponding simulated blood pumping system 200 will be activated. Specifically, the coded signals determine activation of the pump 212 and computer-controlled valve 214 selections. In a preferred embodiment, each control 402, 404, 406 and 408 on remote control 400 corresponds to an individual wound appliance 300 that can be individually activated.

In an embodiment, a master control 404, shown in FIG. 5, is employed to control activation or deactivation of multiple backpack-mounted simulated blood pumping systems 200 at the same time. A training evolution may call for multiple casualties, such as in mass-casualty training scenarios, and the master control 420 allows the director of the scenario to command activation of multiple backpack-mounted simulated blood pumping systems 200 and thus multiple wound appliances 300 simultaneously. The master control 420 is formed with sufficient controls 406 to allow activation and deactivation of individual wound appliances 300 or multiple wound appliances 300 simultaneously. The master control 420 is designed to transmit discrete RF signals corresponding to specific simulated blood pumping systems 200 to be received by antennas 208, similar to remote 400. In a preferred embodiment, each control 422 on the master control 420 corresponds to an individual simulated blood pumping system 200. Also, master controller 420 may be equipped with control buttons 424 that correspond to each wound appliance 300. Alternatively, the master controller 420 may be programmed to activate or deactivate multiple wound appliances 300 with the activation of a single control 422.

An embodiment of the invention includes a computer-controlled valve 214 that discharges simulated blood to the connected supply hoses 216 predicated on user selection from the wired control 210, remote control 400, or master control 420 in use. The computer-controlled valve 214 is formed with an intake to receive simulated blood 203 that is pumped through pump 212 from reservoir 202, and output to supply a sufficient number hoses 216 to provide simulated blood to all selected wound appliances 300.

FIG. 2 depicts four supply hoses 216, however this should not be viewed as a limiting characteristic. The invention may be formed with any number of supply hoses practical for the application or feasible given the volume of simulated blood 203 contained in reservoir 202. A manual selector switch 215 is provided to allow the injured person to control the flow of the simulated blood through one or more of the lines 303A-F.

A preferred embodiment of the present invention has provisions for user-selectable flow rate of the simulated blood from the reservoir through the system to the wound appliances 300. In reality, some wounds bleed faster than others; this feature allows the invention to mimic that phenomenon and make the simulated wound appliance 300 “bleed” faster, as in an arterial bleed or slower, as required for a venous bleed. One embodiment accomplishes this by utilizing pre-selected hose diameters that limit the flow rate through the system in a fixed manner. An alternative embodiment includes a manually adjustable flow or pressure restrictor 213 that can be adjusted by the injured person to slow the flow of the simulated blood. Another embodiment allows the user to directly adjust the pump rate and pressure via mechanical controls on the pump 212, or though the computer controller 204, wired control 210, remote control 400, or master control 420.

A preferred embodiment further provides preprogrammed sequences within the computer controller 204 that command the pump 212 and/or the valve 214 to vary the rate and mass flow of the simulated blood 203 through the system in order to mimic actual blood flow from an actual wound. For instance, computer controller 204 may direct pump 212 to intermittently pump to mimic the heart rate of an actual victim.

An embodiment of the invention includes a power supply 206 that supplies power to the computer controller. The power supply 206 may be connected directly to the computer controller, and will supply maximum sustained power required for at least the duration of the simulation or exercise in which the injured person 102 is engaged. This may be accomplished through the use of lightweight Lithium Ion (Li+) or Nickel Metal Hydride (NiMh) batteries, or similar rechargeable systems known in the art. An embodiment may also use replaceable batteries, for use when the system is employed in an environment absent availability of a standard wall socket for recharging purposes.

While there have been shown what are presently considered to be preferred embodiments of the present invention, it will be apparent to those skilled in the art that various changes and modifications can be made herein without departing from the scope and spirit of the invention,

I claim:

1. A simulated blood pumping system for realistic emergency medical training comprising:
a reservoir containing a volume of simulated blood;
one or more wound appliances, each said wound appliance having a simulated wound in fluid communication with a wound hose;
a means for pumping said simulated blood from said reservoir to said wound hose and through said simulated wound.

2. The simulated blood pumping system for realistic emergency medical training of claim 1, wherein said means for pumping further comprises a pump.

3. The simulated blood pumping system for realistic emergency medical training of claim 2, wherein said means for pumping further comprises a means for controlling said means for pumping.

4. The simulated blood pumping system for realistic emergency medical training of claim 3, where said means for controlling further comprises a controller electrical connection with a wired control wherein activation of said wired control**

5. The simulated blood pumping system for realistic emergency medical training of claim 3, wherein said means for controlling further comprises a remote control.

6. The simulated blood pumping system for realistic emergency medical training of claim 3, wherein said means for controlling further comprises a master control.

7. The simulated blood pumping system for realistic emergency medical training wherein said reservoir is a collapsible reservoir holding a volume of simulated blood, wherein said volume approximates the actual volume of blood in the human body.

8. The simulated blood pumping system for realistic emergency medical training of claim 1, further comprising a computer controller configured to receive discrete control signals from a wired control.

9. The simulated blood pumping system for realistic emergency medical training of claim 8, further comprising a computer controller configured to receive discrete control signals from a remote control.

10. The simulated blood pumping system for realistic emergency medical training of claim 8, further comprising a computer controller configured to receive discrete control signals from a master control.

11. The simulated blood pumping system for realistic emergency medical training of claim 8, wherein the control signals are coded such that an operator may transmit control signals to the controller to activate said means for pumping.

12. The simulated blood pumping system for realistic emergency medical training of claim 1, further comprising a valve in fluid communication with said reservoir and said wound hose configurable to regulate flow of said simulated blood from said reservoir to said wound appliance.

13. The simulated blood pumping system for realistic emergency medical training of claim 12 wherein said valve further comprises a plurality of supply hoses, each said supply hose selectively attachable to a wound hose.

14. The simulated blood pumping system for realistic emergency medical training of claim 13, further comprising a means for controlling said valve to selectively establish fluid communication from said pump to one or more supply hoses.

15. The simulated blood pumping system for realistic emergency medical training of claim 14, wherein said means for controlling said valve further comprises a computer-controlled valve.

16. The simulated blood pumping system for realistic emergency medical training of claim 13, wherein said each supply hose further comprises a self-sealing connector, and said each wound hose further comprises a corresponding self-sealing connector, wherein when said self-sealing connector is sealed to prevent the flow of said simulated blood when in a first configuration unconnected to said corresponding self sealing connector, and said self-sealing connector establishes a fluid pathway when in a second configuration connected to said corresponding sealing connector.

17. The simulated blood pumping system for realistic emergency medical training of claim 1 wherein said wound appliance further comprises a tourniquet shield.

18. The simulated blood pumping system for realistic emergency medical training of claim 17, wherein said tourniquet shield comprises a plurality of stays within the wound appliance and longitudinally aligned with a users limb.

19. The simulated blood pumping system for realistic emergency medical training of claim 17, wherein said tourniquet shield comprises a curved sheet of semi-rigid material that wraps at least partially around the user's limb

20. The simulated blood pumping system for realistic emergency medical training of claim 1 wherein said wound appliance further comprises a fastening system for fastening said wound appliance around the limb of a user.
